(19) United States
(12) Patent Application Publication
(10) Pub. No.: US 2005/0080875 A1
(43) Pub. Date: Apr. 14, 2005

(54) Architecture that enables a Mobile Virtual Network Operator (MVNO) to create a branded wireless offering

(76) Inventors: Rashesh J. Jethi, Fremont, CA (US); Paul W. Nelson, San Francisco, CA (US); Venkatesan Raghavan, San Francisco, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 10/923,442

(22) Filed: Aug. 20, 2004

Related U.S. Application Data
(63) Continuation-in-part of application No. 10/919,820, filed on Aug. 16, 2004.
(60) Provisional application No. 60/496,973, filed on Aug. 20, 2003.

(51) Int. Cl. G06F 15/16

(52) U.S. Cl. 709/217; 370/328

(57) ABSTRACT

An architecture is presented that enables a Mobile Virtual Network Operator (MVNO) to create a branded wireless offering. An MVNO-enabler (MVNE) system acts as an intermediary between a brand system and a wireless network. The MVNE system controls customer management, order management, applications management, and billing management. In one embodiment, the MVNE system comprises modules for customer management, order management, applications management, and billing management. In another embodiment, the MVNE system comprises interfaces to third party systems that provide these services. In yet another embodiment, the MVNE system can comprise interfaces to a plurality of brand systems, a plurality of wireless networks, and a plurality of third party systems. By using various interfaces, a customized wireless offering can be created.

### CROSS-REFERENCE TO RELATED APPLICATIONS

This application is a continuation-in-part of the following U.S. utility patent application, which is hereby incorporated by reference: Ser. No. 10/______ filed on Aug. 16, 2004, entitled “An Architecture that Enables a Mobile Virtual Network Operator (MVNO) to Create a Branded Wireless Offering.” This application also claims priority from the following U.S. provisional patent application, which is hereby incorporated by reference: Ser. No. 60/496,973, filed on Aug. 20, 2003, entitled “Enabling Private Label Wireless Solutions by Interfacing with Mobile Virtual Network Operators and Wireless Carriers and Providing Additional Services.”

### BACKGROUND OF THE INVENTION

1. Field of the Invention

The present invention is related to an architecture that enables a Mobile Virtual Network Operator (MVNO) to create a branded wireless offering and, more particularly, to a system for enabling an MVNO to create a customized wireless offering. Still more particularly, the present invention is directed to a gateway for an MVNO.

2. Description of the Background Art

Many companies would like to enter the wireless services market, but there is a high barrier to entry. Technology is needed for customer management, order management, applications management, and billing management. Third-party interfaces are needed in order to outsource certain services, such as customer care and distribution and fulfillment. Subscriber interfaces are needed, such as call centers and web portals.

Even more significant is the fact that wireless carriers must provide a nationwide cellular network, voice and data transport, management of the North American numbering plan, and standard (raw) Call Detail Record (CDR) feeds to input into a billing system. Not only are cellular expertise and infrastructure expensive, but the number of subscribers required in order to operate profitably is several million.

In response, new players have emerged in the wireless market. They are known as Mobile Virtual Network Operators (MVNOs). MVNOs offer branded wireless services, including the customer management, order management, applications management, and billing management technology mentioned above. However, MVNOs do not have wireless networks. Instead, MVNOs rely on network operators to provide the underlying equipment and communication capabilities, interfacing their systems with network operator systems as necessary. In general, each MVNO offers wireless services under a different brand.

While MVNOs do not operate wireless networks, implementing the rest of a branded wireless offering still requires a great deal of time and other resources. MVNOs need to provide subscriber interfaces, third-party interfaces, and technology for customer management, order management, applications management, and billing management. In addition, these services must be interconnected to provide a complete solution. These costs and complexities prevent many consumer brands from entering the wireless services market and becoming MVNOs.

What is needed is a way to handle the above costs and complexities, thereby enabling consumer brands to be MVNOs.

### SUMMARY OF THE INVENTION

The present invention overcomes the limitations of the prior art by providing a system and method that enables a Mobile Virtual Network Operator (MVNO) to create a branded wireless offering. An MVNO-enabler (MVNE) system acts as an intermediary between a brand system and a wireless network and comprises a brand system interface and a wireless network interface. Together, the MVNE system, brand system, and wireless network provide a branded wireless offering.

The MVNE system controls customer management, order management, applications management, and billing management. The MVNE system comprises a gateway and a plurality of adapters for coupling other systems to the gateway. In one embodiment, the MVNE system also comprises modules for customer management, order management, applications management, and billing management. In another embodiment, the MVNE system comprises interfaces to third party systems that provide these services.

In another embodiment, the MVNE system enables an MVNO to create a customized wireless offerings for a plurality of brands. In this embodiment, the MVNE system can comprise interfaces to a plurality of brand systems, a plurality of wireless networks, and a plurality of third party systems. By using various interfaces, a customized wireless offering can be created.

### BRIEF DESCRIPTION OF THE DRAWINGS

FIG. 1 illustrates a block diagram of a prior art system that provides a branded wireless offering.

FIG. 2A illustrates a block diagram of a system that provides a branded wireless offering, according to one embodiment of the invention.

FIG. 2B illustrates a block diagram of a system that provides a branded wireless offering, according to another embodiment of the invention.

FIG. 3 illustrates a block diagram of a system that provides a customizable branded wireless offering, according to one embodiment of the invention.

FIG. 4A illustrates a block diagram of a system that provides a customizable branded wireless offering, according to another embodiment of the invention.

FIG. 4B illustrates a block diagram of a system that provides a customizable branded wireless offering, according to yet another embodiment of the invention.

FIG. 5 illustrates a block diagram of a system that provides a customizable branded wireless offering, according to one embodiment of the invention.

The Figures depict a preferred embodiment of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF THE EMBODIMENTS

Being an MVNO can help a consumer brand leverage a strong brand, customer base, distribution, marketing, and sometimes also proprietary content to create a unique wireless service offering. Creating a branded wireless offering financially benefits consumer brands by deriving additional value from existing customers, distribution channels, and brand equity. Successful branded offerings will yield consumer brands with a new stream of large, recurring subscriber revenue, a new branded channel for communicating with customers, and a unique means to enhance loyalty programs and deepen customer relationships.

The existence of MVNOs is also financially beneficial to network operators. MVNOs can dramatically improve subscriber profitability, fill excess network capacity, and provide a highly efficient means to access untapped consumer markets. Through MVNOs, network operators can create a highly profitable wholesale business, improve their return on invested capital, and leverage established brands to reduce customer acquisition expenses.

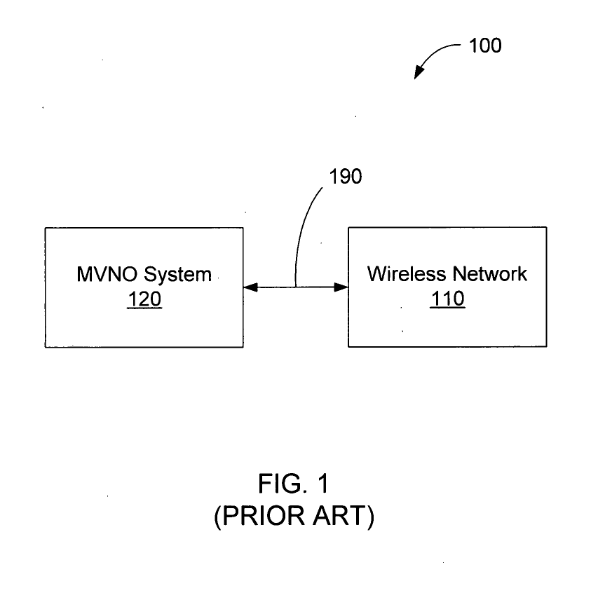

FIG. 1 illustrates a block diagram of a prior art system that provides a branded wireless offering. The illustrated embodiment of system 100 includes one MVNO system 120, one wireless network 110, and a network 190. MVNO system 120 is coupled to wireless network 110 via network 190.

In the illustrated embodiment, wireless network 110 comprises a wireless network, including underlying equipment and communication capabilities. For example, wireless network 110 comprises or interacts with wireless base stations, mobile switching centers, messaging service centers (such as short MSCs and multimedia MSCs), home location registers (HLR), and a wired line carrier. Wireless network 110 enables services such as, for example, provisioning, call detail record (CDR) retrieval, trouble ticketing, coverage, suspension, wireless number portability (WNP), and operational support systems/business support systems (OSS/BSS) integration. When an MVNO customer uses a wireless device to make a phone call, the call travels through wireless network 110.

In the illustrated embodiment, MVNO system 120 is a computer system that implements the rest of the branded wireless offering (e.g., everything except the wireless network 110). In one embodiment, MVNO system 120 provides subscriber interfaces and technology for customer management, order management, applications management; and billing management, interconnecting these services to provide a complete solution. In another embodiment, MVNO system 120 also provides marketing, customer acquisition, and branding of the wireless offering.

MVNO system 120 can comprise, for example, a single computer or a plurality of interconnected computers. These computers can be general-purpose computers or computers that have been configured to perform the functions described above. MVNO system 120 can also comprise one or more databases to store, for example, customer information, order information, and billing information.

In one embodiment, network 190 is a public network, such as the Internet. In another embodiment, network 190 is a private IP-based Local Area Network (LAN) or Wide Area Network (WAN). The communication links to and from network 190 can be wire line or wireless (i.e., terrestrial- or satellite-based transceivers).

1. System for Providing a Branded Wireless Offering

As discussed above, while MVNOs do not operate wireless networks, they still face the costs and complexities of implementing the rest of a branded wireless offering. If MVNOs could outsource some of these costs and complexities, consumer brands would be more likely to enter the wireless services market.

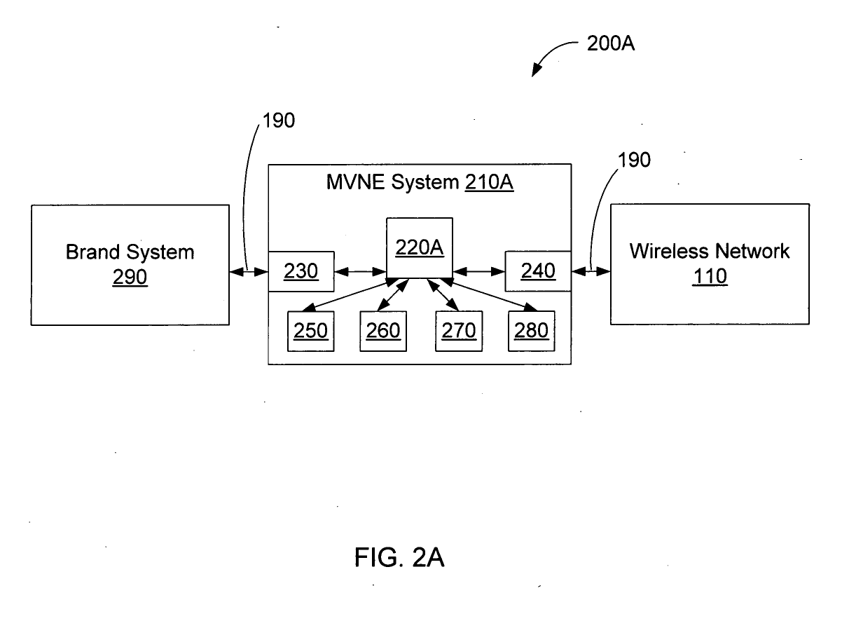

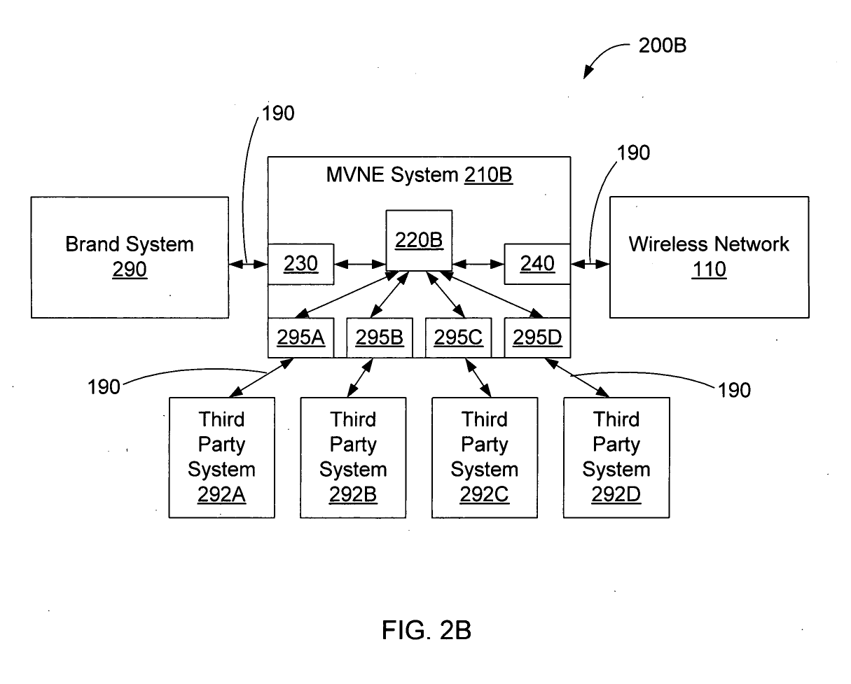

FIG. 2A illustrates a block diagram of a system that provides a branded wireless offering, according to one embodiment of the invention. The illustrated embodiment of system 200A includes one MVNO-enabler (MVNE) system 210A, one brand system 290, one wireless network 110, and a network 190. MVNE system 210A interacts with brand system 290 and wireless network 110, acting as an intermediary between them. MVNE system 210A has two interfaces, 230 and 240, which enable it to interact (via network 190) with brand system 290 and wireless network 110, respectively.

In the illustrated embodiment, brand system 290 is a computer system that provides marketing, customer acquisition, and branding of the wireless offering. Brand system 290 is similar to MVNO 120, except that brand system 290 does not provide technology for customer management, order management, applications management, and billing management. Instead, these services are provided by MVNE system 210A.

In the illustrated embodiment, MVNE system 210A includes customer management module 250, order management module 260, applications management module 270, and billing management module 280. In the illustrated embodiment, MVNE system 210A also includes a control module 220A, which controls MVNE system 210A and interconnects interfaces 230 and 240 and customer management module 250, order management module 260, applications management module 270, and billing management module 280.

In one embodiment, customer management module 250 controls customer relationship management, including work orders, service orders, trouble tickets, premises management, billing management, loyalty and retention, fraud management, credit management, and contract management. In another embodiment, order management module 260 controls sales, activations, product catalogs, and product campaigns. In yet another embodiment, applications management module 270 controls a messaging framework and an application framework. In yet another embodiment, billing management module 280 controls billing, rating, prepayment, taxation, and revenue assurance.

In the illustrated embodiment, wireless network 110 and network 190 perform similar functions as described above with respect to the embodiment illustrated in FIG. 1.

FIG. 2B illustrates a block diagram of a system that provides a branded wireless offering, according to another embodiment of the invention. The illustrated embodiment of system 200B includes one MVNO-enabler (MVNE) system 210B, one brand system 290, one wireless network 110, four third party systems 292A, 292B, 292C, 292D, and a network 190. MVNE system 210B interacts with brand system 290, wireless network 110, and third party systems 292, acting as an intermediary between them.

Similar to the embodiment illustrated in FIG. 2A, MVNE system 210B has two interfaces 230 and 240, which enable it to interact with brand system 290 and wireless network 110. In contrast to the embodiment illustrated in FIG. 2A, in this embodiment, MVNE system 210B does not comprise customer management module 250, order management module 260, applications management module 270, and billing management module 280.

Instead, these services are provided by third party systems 292. In the illustrated embodiment, third party system 292A provides customer management services, third party system 292B provides order management services, third party system 292C provides applications management services, and third party system 292D provides billing management services. In one embodiment, third party system 292A comprises Siebel Communications™ software from Siebel Systems, Inc. In another embodiment, third party system 292D comprises Infinys™ Geneva™ Rating and Billing software from Convergys Corporation.

In the illustrated embodiment, MVNE system 210B comprises customer management interface 295A, order management interface 295B, applications management interface 295C, and billing management interface 295D. In the illustrated embodiment, MVNE system 210B uses interface 295A, 295B, 295C, 295D to communicate, via network 190, with third party systems 292A, 292B, 292C, 292D, respectively. In the illustrated embodiment, MVNE system 210B also includes a control module 220B, which controls MVNE system 210B and interconnects interfaces 230, 240, 295A, 295B, 295C, and 295D. Control module 220B is similar to control module 220A in that it controls MVNE system 210B and interconnects interfaces 230, 240. However, control module 220B differs from control module 220A in that it interconnects interfaces 295A, 295B, 295C, and 295D instead of modules 250, 260, 270, 280.

In the illustrated embodiment, brand system 290, wireless network 110, and network 190 perform similar functions as described with respect to the embodiment illustrated in FIG. 2A.

2. System for Providing a Customizable Branded Wireless Offering

It is beneficial for an MVNE to work with several MVNOs so that the MVNE and MVNOs can take advantage of economies of scale. For example, the MVNE can offer to buy large amounts of airtime from an operator of a wireless network 110 in exchange for obtaining a discounted price. As another example, the MVNE can service multiple MVNOs using the same software. When savings from these economies of scale are passed on to MVNOs, they can drastically lower the number of subscribers needed by an MVNO to operate profitably, thereby encouraging consumer brands to enter the wireless services market.

The present invention enables an MVNE to offer an MVNO a choice of services, such as different wireless carriers, different billing providers, and different content providers. In other words, with the present invention, an MVNE can offer customized product and service offerings. For an inflexible MVNE, creating and operating a custom infrastructure to interact with each brand system 290 does not make financial sense. Therefore, the system of the present invention is particularly advantageous because it enables an MVNE to create customized wireless offerings for brand systems 290. Such a system also enables an MVNE to change aspects of a particular branded wireless offering over time if desired.

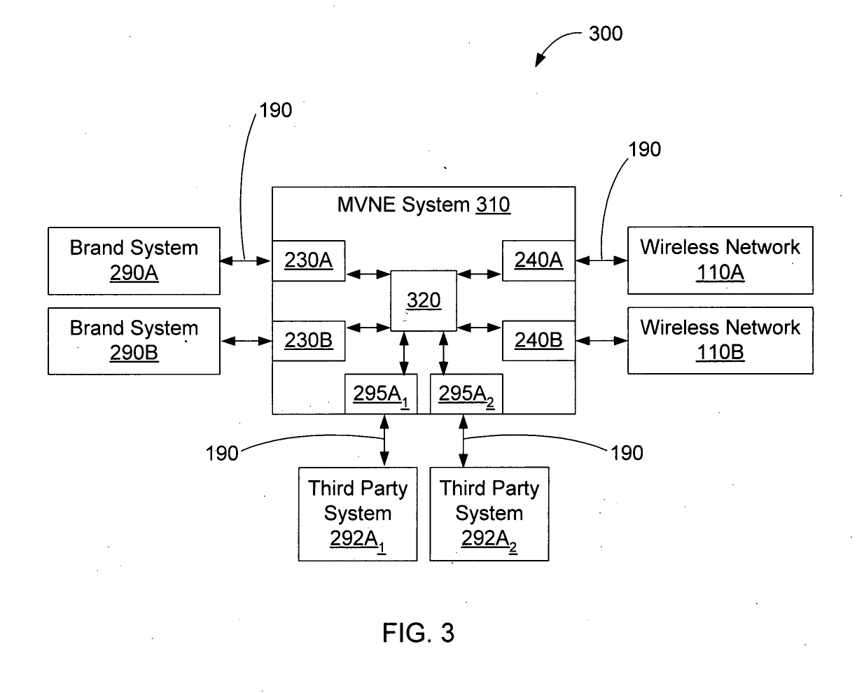

FIG. 3 illustrates a block diagram of a system that provides a customizable branded wireless offering, according to one embodiment of the invention. The illustrated embodiment of system 300 includes one MVNE system 310, a plurality of brand systems 290A, 290B, a plurality of wireless networks 110A, 110B, a plurality of third party systems 292A₁, 292A₂ and a network 190. MVNE system 310 interacts with brand systems 190, wireless networks 110, and third party systems 292A, acting as an intermediary between them.

In the illustrated embodiment, MVNE system 310 includes six interfaces, 230A, 230B, 240A, 240B, 295A₁, and 295A₂. Brand system interfaces 230A, 230B enable MVNE system 310 to interact with two brand systems 290, 290B. Although the illustrated embodiment includes two brand system interfaces 230, MVNE system 310 can have any number of brand system interfaces 230.

Wireless network interfaces 240A, 240B enable MVNE system 310 to interact with two wireless networks 110A, 110B. Third party system interfaces 295A₁, 295A₂ enable MVNE system 310 to interact with two third party systems 292A₁, 292A₂. Although the illustrated embodiment includes two wireless network interfaces 240 and two third party system interfaces 295, MVNE system 310 can have any number of wireless network interfaces 240 and third party system interfaces 295.

In the illustrated embodiment, MVNE system 310 also includes a control. module 320, which controls MVNE system 310 and interconnects interfaces 230A, 230B, 240A, 240B, 295A₁, 295A₂. MVNE system 310 also includes (not shown) customer management module 250, order management module 260, applications management module 270, and billing management module 280 (as described above with reference to FIG. 2A) or customer management interface 295A, order management interface 295B, applications management interface 295C, and billing management interface 295D (as described above with reference to FIG. 2B).

In the illustrated embodiment, brand systems 290, wireless networks 110, and network 190 perform similar functions as described above with respect to the embodiment illustrated in FIG. 2A.

Although system 300 includes two brand systems 290, two wireless networks 110, and two third party systems 292A, system 300 can have any number of brand systems 290, wireless networks 110, and third party systems 292A. For example, a branded wireless offering for MVNO A can include one brand system 290A, one wireless network 110A, and one third party system 292A₁ (e.g., a billing provider). Similarly, a branded wireless offering for MVNO B can include a different brand system 290B, a different wireless network 110B, and a different third party system 292A₂ (e.g., a different billing provider).

If MVNO A wants to offer its customers a choice of wireless networks 110, system 300 can include wireless network 110A and wireless network 110B. If MVNO A wants a third party to handle customer care, system 300 can include an additional third party 292B (e.g., a customer care provider). If MVNO A wants billing to be handled by MVNE system 310 rather than by a third party, system 300 can exclude third party system 292A₁. In this embodiment, MVNE system 310 would also include billing management module 280.

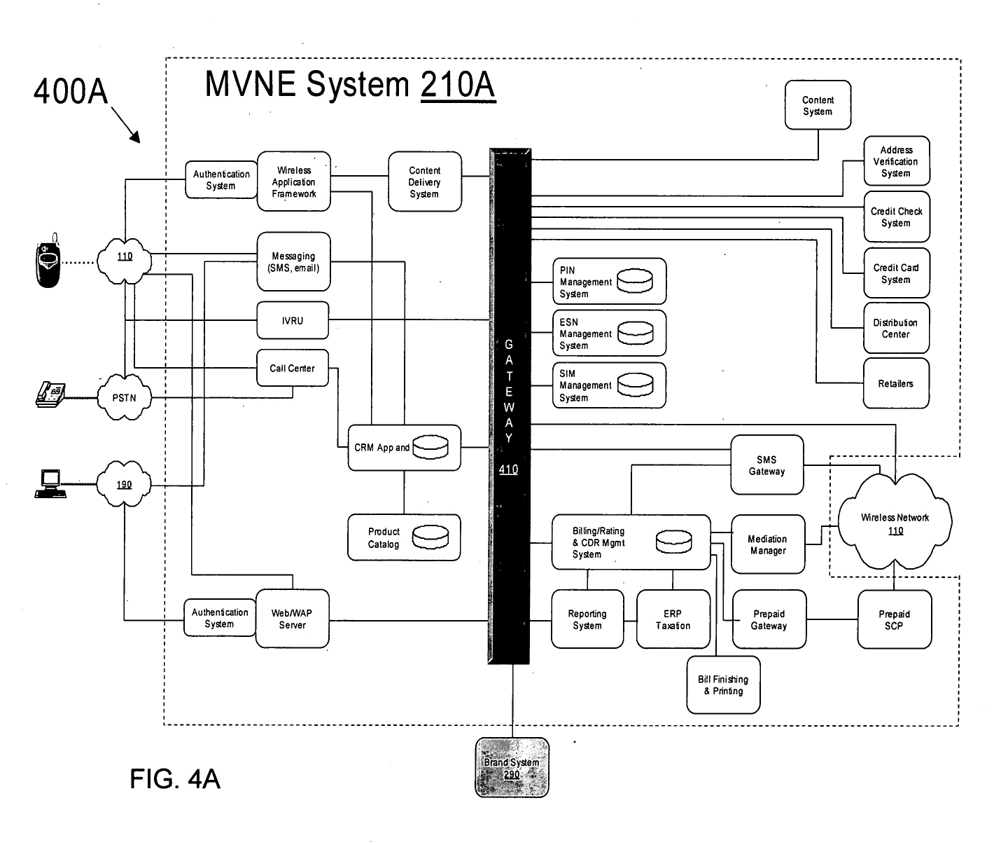

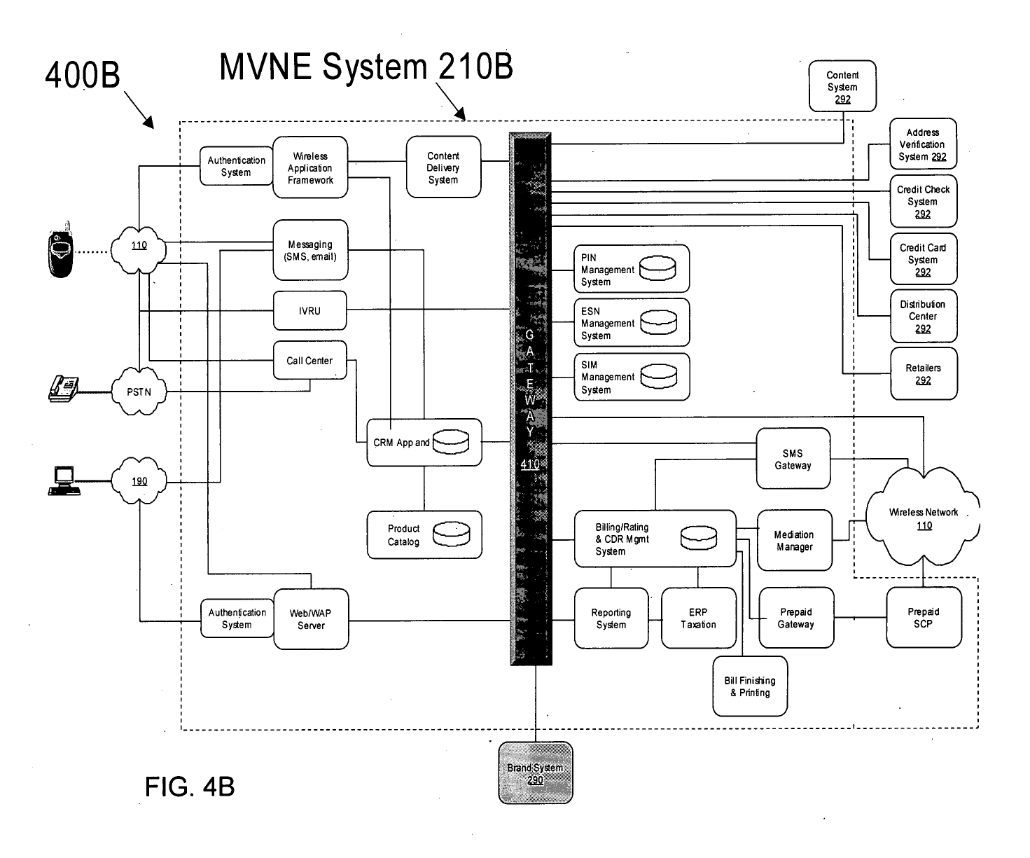

FIG. 4A illustrates a block diagram of a system that provides a customizable branded wireless offering, according to another embodiment of the invention. In the illustrated embodiment, system 400A includes one MVNO-enabler (MVNE) system 210A, one brand system 290, one wireless network 110, a network 190, and a public switched telephone network (PSTN). Devices that can be coupled with system 400A include, for example, a wireless phone, a landline phone, and a computer.

MVNE system 210A interacts with brand system 290 and wireless network 110, acting as an intermediary between them. MVNE system 210A has two interfaces, 230 and 240 (not shown), which enable it to interact with brand system 290 and wireless network 110, respectively. MVNE system 210A also has a gateway 410, which will be further described below.

In the illustrated embodiment, MVNE system 210A includes a content system, an address verification system, a credit check system, a credit card system, a distribution center system, and a retailer system. The content system stores content that will be sent to the wireless application framework (WAF) system and then presented to the user. The address verification system enables address verifications for customers of various systems. In one embodiment, the address verification system uses payment handler functionality of the billing system. The credit check system enables credit verifications for customer payments. The credit card system performs credit card authorization, settlement, and charge reversal transactions. In one embodiment, the credit card system uses payment handler functionality of the billing system. In one embodiment, the distribution center system integrates with the gateway 410 through APIs defined by the distribution center. In one embodiment, the retailer system includes two components. The first component is to the retailer points of sale and enables ESN locking/unlocking and PIN activation/deactivation. The second component is for handset and accessory sales.

MVNE system 210A also includes both front-end and back-end components. Front-end components include, for example, a wireless application framework (WAF) and authentication system, a content delivery system, a messaging system, an interactive voice response unit (IVRU), a call center system, a customer relationship management (CRM) application and master customer database (DB), a product catalog system, and a world-wide web/wireless application protocol (WAP) and authentication system.

The WAF system facilitates the integration of applications and content into the wireless network 110. In one embodiment, the WAF system enhances and customizes users' experiences based on their locations, messaging capabilities, user profiles, etc. In one embodiment, the WAF system includes a content management system, a service creation and execution environment, and a presentation layer.

The messaging system handles messages, such as email, SMS, and MMS, sent by and to users and systems. The IVRU interfaces with the CRM application and the gateway 410 and enables users to interact with system 210A. The call center system is used by a call center that answers users' phone calls.

The CRM application is used by customer care agents who support sales, provisioning, billing, and marketing transactions. In one embodiment, the CRM application integrates with the gateway 410 using enterprise application integration (EAI) and also integrates with the call center system. In one embodiment, the CRM application comprises Siebel Communications™ software from Siebel Systems, Inc., including Siebel's Gateway Server, Enterprise Server, Web Engine Server, Application Server, and Database Server. In one embodiment, the CRM system interfaces with the gateway 410 using XML over HTTP and an adapter using the J2EE Connector Architecture (JCA).

The product catalog system includes a database and is used by consumers and providers for sales purposes. The worldwide web/WAP system includes web portals that can be used by consumers, brand system 290 administrators, and MVNE system 210 administrators.

Back-end components include, for example, a personal identification number (PIN) management system, an equipment serial number (ESN) management system, a subscriber identity module (SIM) management system, a short message service (SMS) gateway, a billing/rating and call detail record (CDR) management system, a reporting system, an enterprise resource planning (ERP) taxation system, a bill finishing and printing system, a mediation manager system, a prepaid gateway system, and a prepaid service control point (SCP) system).

The PIN management system includes a data repository of PINs and applications that manage the lifecycle of the PINs. In one embodiment, the PINs belong to cards that are used for a pre-paid wireless offering. The ESN management system includes a data repository of ESNs for mobile devices (that the MVNE system 210 knows of and allows interaction with) and applications that manage the lifecycle of the ESNs. In one embodiment, the ESN management system also interfaces with retailer systems, brand systems 290, distribution center systems, and the CRM system via the gateway 410. The SIM management system includes a data repository of SIMs and applications that manage the lifecycle of the SIMs. In one embodiment, the billing system includes an ERP taxation component. In one embodiment, the billing system includes Infinys™ Geneva™ Rating and Billing software from Convergys Corporation.

In the illustrated embodiment, brand system 290, wireless network 110, and network 190 perform similar functions as described above with respect to the embodiment illustrated in FIG. 2A.

FIG. 4B illustrates a block diagram of a system that provides a customizable branded wireless offering, according to yet another embodiment of the invention. In the illustrated embodiment, system 400B includes one MVNE system 210B, one brand system 290, one wireless network 110, a network 190, and a public switched telephone network (PSTN). Devices that can be used to interface with system 400B include, for example, a wireless phone, a landline phone, and a computer.

MVNE system 210B interacts with brand system 290 and wireless network 110, acting as an intermediary between them. Similar to the embodiment illustrated in FIG. 4A, MVNE system 210B has two interfaces 230 and 240 (not shown), which enable it to interact with brand system 290 and wireless network 110, respectively. MVNE system 210B also includes a gateway 410, front-end components and back-end components. In contrast to the embodiment illustrated in FIG. 4A, in this embodiment, MVNE system 210B does not include a content system, an address verification system, a credit check system, a credit card system, a distribution center system, and a retailer system.

Instead, these systems 292 are provided by third parties. In the illustrated embodiment, third party systems 292 include a content system, an address verification system, a credit check system, a credit card system, a distribution center system, and a retailer system. In the illustrated embodiment, MVNE system 210B also includes third party system interfaces 295 (not shown). Additionally, the gateway 410 is modified from that in FIG. 4A because the gateway 410 include adapter to connect to the third party systems 292.

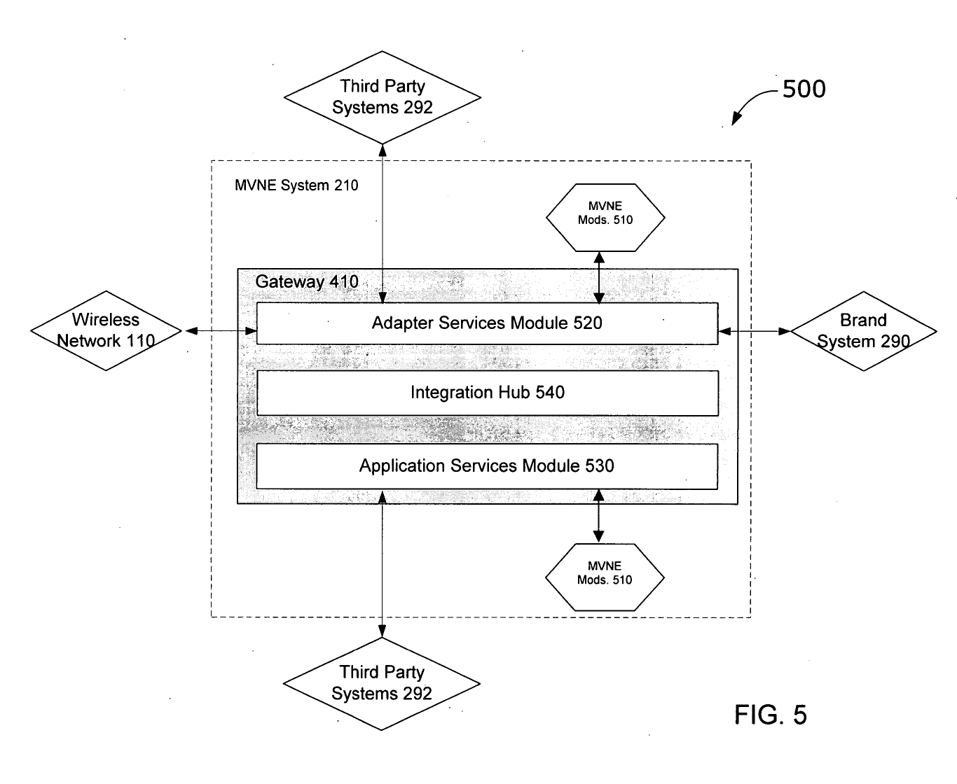

FIG. 5 illustrates a block diagram of a system that provides a customizable branded wireless offering, according to one embodiment of the invention. In the illustrated embodiment, system 500 includes one wireless network 110, one brand system 290, one MVNE system 210 and various third party systems 292. In the illustrated embodiment, the MVNE system 210 comprises gateway 410 and various MVNE modules 510. Gateway 410 further includes an adapter services module 520, an application services module 530 and an integration hub 540.

FIG. 5 illustrates a hybrid approach different from those of other embodiments. In particular, FIG. 5 illustrates how the MVNE system 210 may be coupled to a plurality of third party systems 292 as well as includes a plurality of MVNE modules 510. Other alternate embodiments would have a similar functionality in the gateway 410 modified to match the number of third party systems 292 and MVNE modules 510. For example similar to FIG. 4A, in a first alternate embodiment (not shown), no third party systems 292 are needed or coupled to the gateway 410, but rather all the functionality would be handled by separate MVNE modules 510. In such a case, the adapter services module 520 does not have adapters for third party system 292. In contrast in a second alternate embodiment, the MVNE system 210 could have no MVNE modules 510, but instead rely on third party systems 292 for all the functionality. In such a case, the adapter services module 520 has several adapters, one for each third party system 292 to which the gateway 410 couples. Those skilled in the art will recognize that any of the front-end components and back-end components can each be either in MVNE system 210 (as MVNE modules 210) or third party systems 292, depending on the MVNO's desires. Thus, the MVNE system 210 of the present invention provides the maximum flexibility to configure the system 500 and include functionality as desired.

A key component of the gateway 410 is the integration hub 540. The integration hub 540 forms the backbone of the MNVE system 210 architecture. The integration hub 540 is coupled to various third party systems 292 and MVNE modules 510 and in one manner or the other and it encompass numerous interrelated functions. The integration hub 540 includes a set of interconnected functions for communication with the various third party systems 292 and MVNE modules 510. The integration hub 540 is coupled to the application services module 530 for implementation of areas that relate business components whose implementation may be coupled with Workflow. The integration hub 540 is coupled to the adapter services module 520 for implementation of areas that relate to service components and involves inter-component messaging. The integration hub 540 may also be coupled to receive and process user interaction. The integration hub 540 also facilitates the free flow of data by allowing data to be converted into a universal form by the adapter services module 520. The conversion format is, in theory, “independent” of the application services module 530 that has components/applications that are passing data between themselves. The independent form is known preferably a canonical form. In one embodiment, the application that is considered to hold the master data will describe the prototype of the canonical form.

The adapter services module 520 is provided to facilitate the integration of 3^{rd} party systems 292. The adapter services module 520 includes adapters for various internal and 3^{rd} party systems 292 and to integrate seamlessly with them. For example, the adapters include interface technologies such as the following will be used to talk to these external components: MDB wrapper over XML/Http interface, API wrapper over XML/Http interface, EJB wrapper over CORBA, API wrapper over SOAP XML/Http interface, Socket Server for POSA, and API wrapping Stored Procedures.

The application services module 530 is provided to facilitate the creation of interactive services. The application services module 530 provides services to facilitate transactions between all components, overlaid with system workflow. Specifically, at the transaction level, the application services module 530 will offer: transaction persistence, rollbacks, journaling, Error Handling and queuing.

3. Additional Embodiments

Any services, such as front-end, back-end, content/media, retail, payment, and equipment distribution, can be handled by an MVNE system 210 or 310, a brand system 290, or a third party system 292, depending on the MVNO's preferences. Front-end services include, for example, marketing, order entry, activation, customer care, lifecycle management, content provision, and bundled offers. Back-end services include, for example, retailer APIs and portals, billing, rating, mediation, reporting, distribution and fulfillment, reverse logistics, bill presentment, credit checks, finance taxation, and payments. If a third party system 292 is present, it can interface with either the MVNE system 210 or 310 or the brand system 290.

In the above description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatuses to perform the required method steps. The required structure for a variety of these systems appears from the description. In addition, the present invention is not described with reference to any particular programming language. It will be appreciated that a variety of programming languages may be used to implement the teachings of the invention as described herein.

One skilled in the art will recognize that the particular examples described herein are merely illustrative of representative embodiments of the invention, and that other arrangements, methods, architectures, and configurations may be implemented without departing from the essential characteristics of the invention. Accordingly, the disclosure of the present invention is intended to be illustrative, but not limiting, of the scope of the invention, which is set forth in the following claims.

1. A device for providing wireless communication services, comprising:
an integration hub having an input and an output for enabling communication between modules;
a first module having an input and an output for providing adapter services, the input and the output of the first module coupled to the integration hub; and
a second module having an input and an output for providing application services, the input and the output of the second module coupled to the integration hub.

2. The device of claim 1, wherein the integration hub includes an interconnection function for communication with a third party system.

3. The device of claim 1, wherein the integration hub includes an interconnection function for communication with an MVNE module.

4. The device of claim 1, wherein the integration hub includes an interconnection to receive user input.

5. The device of claim 1, wherein the first module translates data from a third party format to a format for the second module.

6. The device of claim 1, wherein the first module translates data from a third party format to a universal format.

7. The device of claim 6, wherein the universal format is a canonical form.

8. The device of claim 1, wherein the first module includes an interface to communicate with a third party component, and the interface is one from the group of: MDB wrapper over XML/Http interface, API wrapper over XML/Http interface, EJB wrapper over CORBA, API wrapper over SOAP XML/Http interface, Socket Server for POSA, and API wrapping Stored Procedures.

9. The device of claim 1, wherein the second module facilitates the creation of interactive services.

10. The device of claim 1, wherein the second module provides services to facilitate transactions between an MVNE module and a third party system.

11. The device of claim 1, wherein the second module performs one from the group of transaction persistence, rollbacks, journaling, error handling and queuing.

12. A system for controlling a mobile virtual network including a branding system and a wireless network, the system comprising:
a gateway having an input and an output for acting as an intermediary and communicating with the branding system and the wireless network, the gateway coupled to the branding system and the wireless network; and
a first module for performing a function of a mobile virtual network, the first module having an input and an output, the input and output of the first module coupled to the gateway.

13. The system of claim 12 wherein the gateway comprises:
an integration hub having an input and an output for enabling communication between modules;
an adapter module having an input and an output for providing adapter services, the input and the output of the adapter module coupled to the integration hub; and
an application module having an input and an output for providing application services, the input and the output of the application module coupled to the integration hub.

14. The system of claim 13, wherein the integration hub includes an interconnection function for communication with a third party system.

15. The system of claim 13, wherein the integration hub includes an interconnection function for communication with an MVNE module.

16. The system of claim 13, wherein the adapter module translates data from a third party format to a format for the application module.

17. The system of claim 13, wherein the adapter module translates data from a third party format to a canonical format.

18. The system of claim 16, wherein the adapter module includes an interface to communicate with a third party component, and the interface is one from the group of: MDB wrapper over XML/Http interface, API wrapper over XML/Http interface, EJB wrapper over CORBA, API wrapper over SOAP XML/Http interface, Socket Server for POSA, and API wrapping Stored Procedures.

19. The system of claim 13, wherein the application module facilitates the creation of interactive services.

20. The system of claim 13, wherein the application module performs one from the group of transaction persistence, rollbacks, journaling, error handling and queuing.

21. The system of claim 12, wherein the gateway includes an adapter for enabling communication with a third party system, and wherein the system including an interface for coupling to a third party system.

22. The system of claim 12, wherein the gateway includes a plurality of adapters, each adapter for enabling communication with a third party system, and wherein the system including a plurality of interfaces for coupling to third party systems.

23. The system of claim 21, wherein the third party system is one from the group of: a content system, a billing system, a verification system, a credit card system, a distribution center and a retailer.

24. The system of claim 12, further comprising a MVNE module having an input and an output for performing a function to support a mobile virtual network, the input and the output of the MVNE module coupled to the gateway.

25. The system of claim 24, wherein the function performed by the MVNE module is one from the group of: billing management, customer management, order management, PIN management, ESN management, SIM management, messaging, payment management, reporting, and prepaid verification.

26. The system of claim 12, further comprising a plurality of MVNE modules having each an input and an output for performing a function to support a mobile virtual network, the input and the output of each MVNE module coupled to the gateway.

27. The system of claim 26, wherein the functions performed by the plurality of MVNE module is a plurality from the group of: billing management, customer management, order management, PIN management, ESN management, SIM management, messaging, payment management, reporting, and prepaid verification.
